(19) United States
(12) Patent Application Publication
(10) Pub. No.: US 2026/0213340 A1
(43) Pub. Date: Jul. 23, 2026

(54) A HOUSING FOR AUTOMOTIVE BATTERIES WITH PROTECTION AGAINST THERMAL DRIFT

(71) Applicant: Maserati S.p.A., Modena (IT)

(72) Inventors: Valter BRAMATI, Modena (IT); Davide RINALDI, Modena (IT); Stefano ZIN, Modena (IT)

(21) Appl. No.: 19/141,190

(22) PCT Filed: Dec. 20, 2023
(86) PCT No.: PCT/IB2023/063021

§ 371 Date: Jun. 19, 2025

(30) Foreign Application Priority Data
Dec. 21, 2022 (IT) 102022000026277

(51) Int. Cl. H01M 50/30; B60L 50/64; H01M 10/0525; H01M 50/249

(52) U.S. Cl. CPC H01M 50/394; B60L 50/64; H01M 50/249; H01M 10/0525; H01M 2220/20

(57) ABSTRACT

A housing for automotive batteries includes an internal volume for housing one or more automotive batteries, the housing including at least one vent valve for venting a flow of fluid from the internal volume to the external environment. The housing includes, in association with each vent valve, a filter element arranged in the internal volume upstream of the vent valve, and configured for intercepting the fluid flow to be vented via the vent valve prior to passing through the vent valve, thereby achieving filtration of the fluid flow.

### FIELD OF THE INVENTION

The present invention refers to electrically powered vehicles, including both hybrid vehicles (HEVs, PHEVs and, to a lesser extent, MHEVs) and exclusively electric vehicles (BEVs).

### PRIOR ART

Automotive batteries are generally subjected, depending on the energy which must be delivered in order to meet the driver's needs, to more or less marked heating phenomena. In order to tackle with such phenomena, the batteries are arranged in a housing which is provided with one or more vent valves, the function whereof consists in venting to the external environment the hot air and the possible overpressure which builds up within the housing. A first problem connected to the configuration of the known housings regards the inability of the vent valves to retain lithium particles, which are harmful to human health and which can be suspended in the air within the housing during overheating. When the air is expelled through the vent valves, it also carries possible lithium particles which have formed within the housing. The prior art has countered this phenomenon by providing filtering/shielding grids downstream of the vent valves.

Such a solution, however, has worsened a much more serious problem, which is intrinsic to automotive batteries: the thermal drift events of the battery assembly within the housing.

Indeed, most heating events are local or do not normally evolve into a generalized thermal drift of the battery assembly. In such cases, the drift is managed and removed by the vent valves only, with the grids located in front (i.e., downstream) of them, in order to prevent the scattering of lithium particles into the atmosphere.

However, in a small (but not negligible) number of instances, the overheating phenomenon also involves, substantially with a domino effect, the whole assembly of batteries in the housing, with a consequent marked increase in temperature and a massive emission of lithium particles.

In this case, the known solution outlined in the foregoing is not only ineffective in preventing an uncontrolled evolution of the thermal drift, but it even promotes such an event: the overheated lithium particles build up at the grids downstream of the vent valves, thereby blocking the movable members thereof and preventing the switching of the latter to the open position.

This results in total destruction by fire of the battery assembly and of the vehicle itself.

Alternatively, the vent valves may collapse due to the high temperature of the depositing particles, therefore resulting in a sudden fire trigger once they combine with ambient air.

Generally, it is to be noted that the vent valves on board the housings for automotive batteries are in any case prone to malfunction in the cases of strong thermal drift events, even in the absence of grids downstream thereof.

### OBJECT OF THE INVENTION

The present invention aims at solving the technical problem outlined in the foregoing. Specifically, the invention aims at providing a housing for automotive batteries, particularly lithium-ion batteries, which is adapted to eliminate even the most sudden and destructive thermal drift phenomenon.

### SUMMARY OF THE INVENTION

The object of the invention is achieved by means of a housing having the features set forth in the claims that follow, which form an integral part of the technical disclosure provided herein with relation to the invention.

### BRIEF DESCRIPTION OF THE FIGURES

The invention will now be described with reference to the annexed drawings, which are provided by way of non-limiting example only, and wherein:

FIG. 1 is a general perspective view of a housing according to the invention,

FIGS. 2 and 3 are views of components respectively identified by the arrows II and III in FIG. 1,

FIG. 4 is a partial perspective view of the housing at the component indicated by arrow II in FIG. 1, while

FIG. 5 is a sectional schematic view of the same component, and

FIG. 6 is a partial perspective view of the housing at the component indicated by arrow III in FIG. 1.

### DETAILED DESCRIPTION

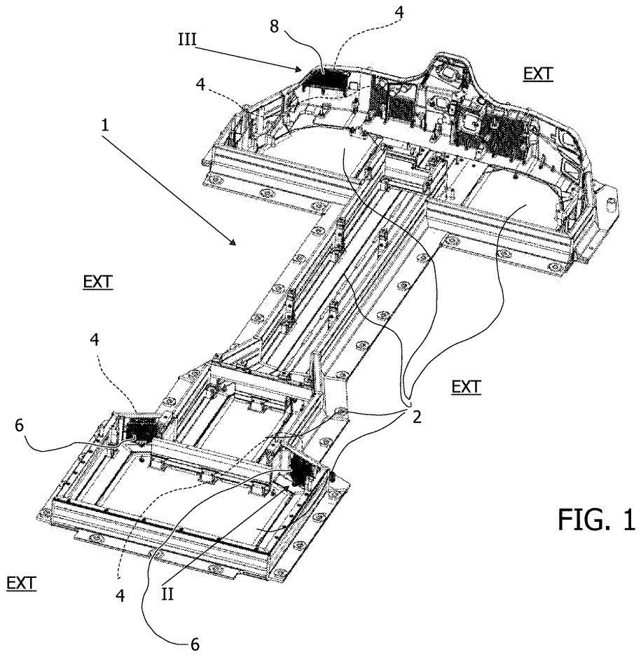

Reference 1 in FIG. 1 generally denotes a housing for automotive batteries according to the invention.

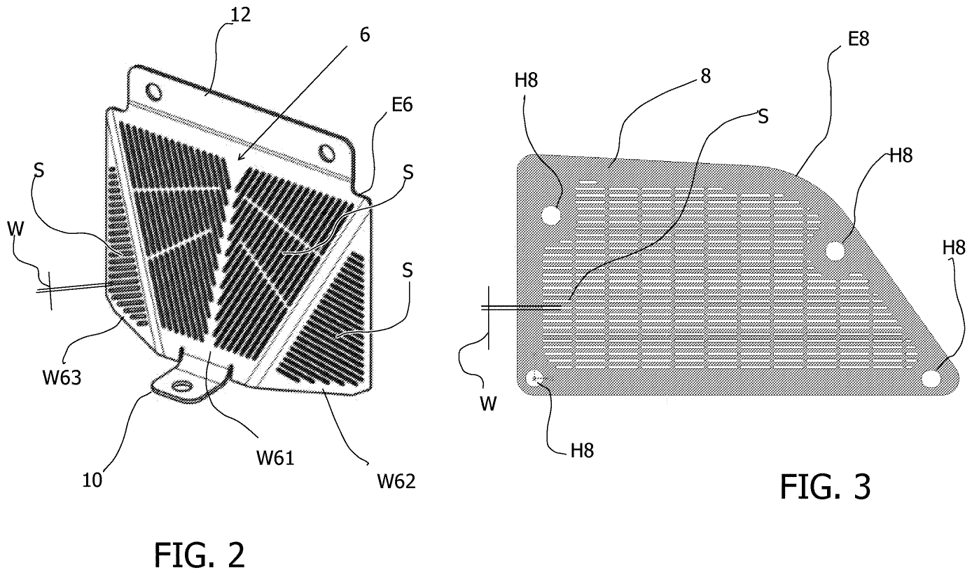

In this embodiment, having a plan made of two opposite “Ts”, the housing 1 comprises an internal volume 2 configured for housing one or more automotive batteries, and at least one vent valve 4 configured for venting a flow of fluid from the internal volume 2 to the external environment EXT. According to the invention the housing 1 includes, in association with each vent valve 4, a filter element 6, 8 arranged in the internal volume 2 upstream of the vent valve 4 itself, and being configured for intercepting the fluid flow to be vented via the vent valve 4 prior to passing through the vent valve 4 itself, thereby achieving filtration of the fluid flow. The filter elements 6, 8 are visible in FIGS. 2 and 3, and are preferably configured as grids, specifically metal sheet grids.

Specifically, each filter element 6, 8 is pervious with respect to a gaseous fraction of the fluid flow, and it is impervious with respect to a solid fraction carried by the gaseous fraction. In other words, the filter elements 6, 8 may be traversed by the hot gas which has formed within housing 1 during a thermal drift event, but they are able to retain upstream thereof the lithium particles suspended in the gaseous flow, therefore preventing them from traversing vent valve 4. Preferably, each filter element is impervious with respect to a solid fraction having a particle size greater than 900 μm.

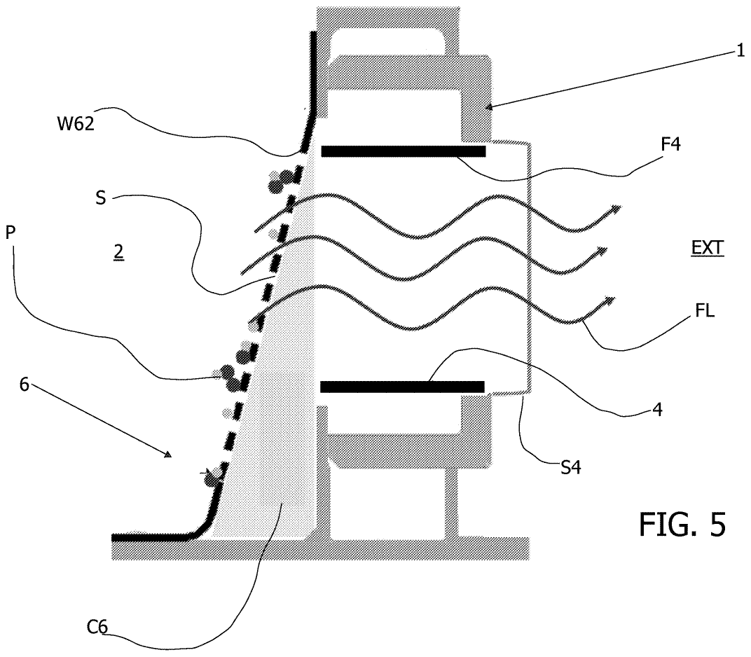

Referring to FIG. 5, each vent valve 4 comprises a flow conduit F4 for passage of the fluid flow coming from the internal volume 2, and a valve element (which is not shown for simplicity) configured for selectively closing and opening the flow conduit F4 to, respectively, prevent and enable the passage of the fluid flow. The flow conduit F4 is preferably provided with a protection lid having an apertured structure S4, which substantially prevents intrusions from the outside.

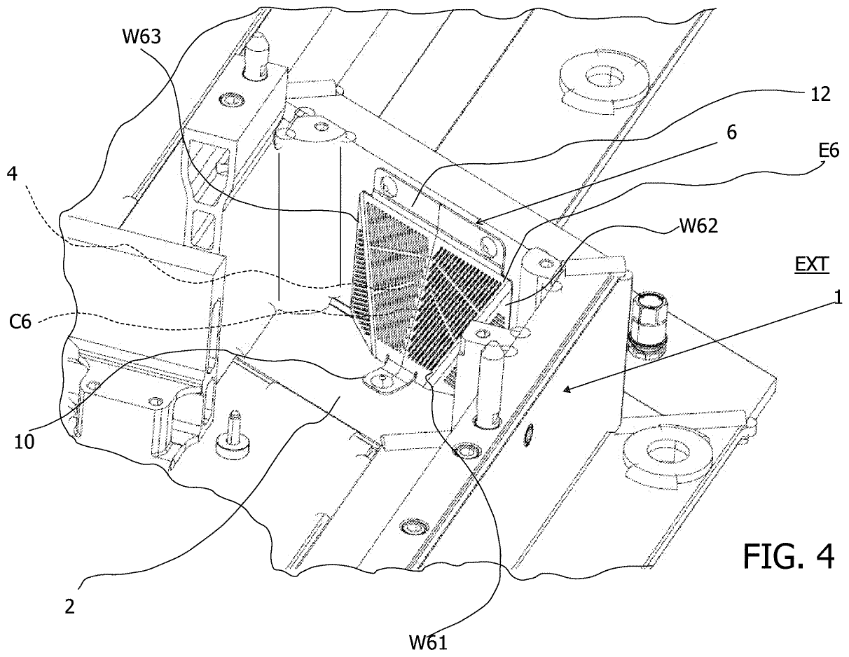

Referring to FIGS. 2, 4, 5, the filter element 6 (which in the following is also designed as “first filter element”) has a polyhedral surface defining a concavity facing said flow conduit F4, and it is preferably configured as a grid, the apertured structure whereof is defined by a plurality of elongated through slits s, having a dimension W transverse to the elongation direction lower than 0.9 mm, and being globally adapted to enable a gas flow equal or higher than enabled by valve S4. More specifically, the dimension W is generally comprised between 0.65 mm and 0.95 mm, preferably between 0.85 mm and 0.9 mm (including the extreme values in both cases).

The polyhedral surface defines a perimeter edge E6, and the filter element 6 is fixed at the perimeter edge E6 around the flow conduit F4, thereby defining a chamber C6 upstream thereof. More specifically, in a preferred embodiment the filter element 6 is made of a metal sheet, comprising a central portion W61 and two lateral portions W62 and W63 which are incident with respect to the portion W61. In other words, the sheet which constitutes the filter element 6 is folded so as to define a pair of subsequent dihedrals W62-W61 and W61-W63, so as to have a shovel-like or spoon-like shape.

Preferably, the fixation within the housing 1 is implemented by means of two fins 10, 12 arranged on the perimeter edge E6 at opposite ends of the filter element and, in the present embodiment, being mutually orthogonal. In this way it is possible to implement a fixation to a bottom-horizontal-wall of housing 1 by means of the fin 10, and to a lateral-vertical-wall of housing 1, wherein the terms “horizontal” and “vertical” are referred to the installation of housing 1 on board a vehicle. In FIG. 5, the shape of the filter element 6 in combination with the shape of the walls of housing 1 in the fixation area form the chamber C6.

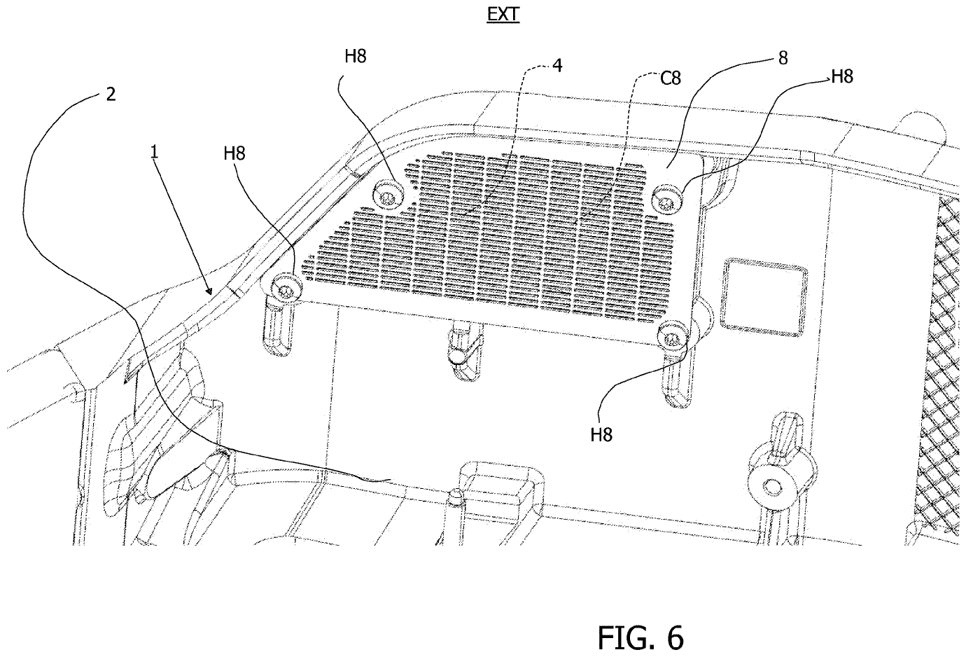

Referring to FIGS. 3, 6, the filter element 8 (in the following also referred to as “second filter element”) has a flat surface directly facing the inlet of flow conduit F4, and is in turn preferably configured as a grid, the apertured structure whereof is defined by a plurality of elongated through slits S, having a dimension W transverse to the elongation direction lower than 0.9 mm, and being globally adapted to enable a gas flow equal or greater than enabled by the vent valve S4. More specifically, the dimension W is generally comprised between 0.65 mm and 0.95 mm, preferably between 0.85 mm and 0.9 mm (including the extreme values in both cases).

The fixation of the second filter element 8 within housing 1 is obtained by applying the element 8 onto a frame surrounding the flow conduit F4 (e. g. a ridge which emerges from the walls of housing 1 towards the interior of volume 2, and which surrounds the conduit F4), and by fixing the element on the frame by means of screws which engage holes H8, thereby defining a chamber C8 upstream of conduit F4. The filter element 8 is preferably shaped in such a way that a perimeter edge E8 thereof has a shape substantially coinciding with a (typically external) perimeter edge of the frame whereon it is fixed.

Unlike filter element 6, the surfaces whereof delimit, on multiple planes, the chamber C6, filter element 8 is substantially a “lid” which closes the frame around conduit F4. The choice of either solution for the filter element essentially depends on the geometry of the housing 1 at the vent valve 4, and generally speaking —as in the embodiment shown in FIG. 1—it is possible to select a combination of at least one first filter element 6 and at least one second filter element 8 (in this specific instance, two elements 6 and an element 8). Of course, solutions are possible wherein only filter elements 6 or only filter elements 8 are envisaged.

Referring to FIG. 5 (which is specific for filter element 6, but which is generally valid also with respect to the features of element 8), in use—and during a thermal drift event of the batteries in the internal volume 2 of housing 1—the housing 1 according to the invention effectively prevents the uncontrolled and/or destructive evolution of such phenomena. In the case of a strong thermal drift, accompanied by the emission of lithium particles P (or generally speaking, of particles of a metal/material which is the basic constituent of the battery), and by an increase of the inner pressure within housing 1 due to air overheating, a fluid flow FL is generated—due to the pressure gradient with respect to the external environment EXT—which is directed from volume 2 towards the environment EXT.

The fluid flow FL comprises a gaseous fraction, essentially consisting of air, and a solid fraction (particles P) suspended in the gaseous fraction. When the fluid flow FL meets the elements 6, 8, i.e., before flowing through the valve 4 and the flow conduit F4 of the latter, thanks to the position of the filter elements 6, 8 the particles P are blocked upstream of the filter elements 6, 8, therefore preventing the passage thereof through the flow conduit F4 and the discharge thereof into the outer environment EXT. The apertured structure of the elements 6, 8 is such that, even in the presence of massive quantities of particles P, the transit of the gaseous fraction through the filter elements 6, 8 is anyway ensured. In other words, the perviousness to gaseous flow is always ensured, as well as the imperviousness to solid particles having a particle size above a given threshold. Unlike the known solutions, the build-up of particles P upstream of the filter elements 6, 8 does not jeopardize in any way the functionality of the vent valves 4, since the particles P are not allowed to transit beyond the barrier provided by the filter elements 6, 8; thus, irrespective of the thermal-chemical-physical conditions of the particles P, such particles do not undergo any interaction with the valves 4, especially with the movable members thereof. It is therefore possible, in a vehicle with a powertrain comprising at least one traction element which is powered by batteries, specifically by lithium-ion batteries, which are housed in the internal volume 2 of housing 1, to ensure a higher safety (to the vehicle and to the passengers) with respect to events of thermal drift of the batteries, thus excluding any uncontrolled and/or destructive evolution of such thermal drift.

Of course, the implementation details and the embodiments may amply vary with respect to what has been described and illustrated, without departing from the scope of the present invention as defined in the annexed claims.

1. A housing for automotive batteries comprising an internal volume configured for housing one or more automotive batteries, the housing including at least one vent valve configured for venting a flow of fluid from said internal volume to the external environment, the housing including:
in association with each vent valve, a filter element disposed in said internal volume upstream of the at least one vent valve and configured to intercept a fluid flow to be vented via the at least one vent valve prior to passing through said at least one vent valve, thereby achieving filtration of said fluid flow.

2. The housing according to claim 1, wherein said filter element is pervious with respect to a gaseous fraction of said fluid flow and is impervious with respect to a solid fraction carried by said gaseous fraction.

3. The housing according to claim 2, wherein said filter element is impervious with respect to the solid fraction having a particle size greater than 900 μm.

4. The housing according to claim 1, wherein the filter element comprises a first filter element and a second filter element, and wherein each vent valve comprises a flow conduit for passage of said fluid flow and a valve element configured to selectively close and open the flow conduit to, respectively, prevent and allow passage of said fluid flow.

5. The housing according to claim 4, wherein the first filter element has a polyhedral surface defining a concavity facing said flow conduit, said polyhedral surface having a perimeter edge and being fixed at said perimeter edge around said flow conduit, thereby defining a chamber upstream thereof.

6. The housing according to claim 4, wherein the second filter element has a flat surface and is fixed to a frame surrounding said flow conduit, thereby defining a chamber upstream thereof.

7. The housing according to claim 1, wherein said filter element is a grid.

8. The housing according to claim 4, comprising a combination of at least one of the first filter element and at least one of the second filter element.

9. The housing according to claim 7, wherein the grid comprises an arrangement of elongated through slits having a dimension transverse to an elongation direction comprised between 0.65 mm and 0.95 mm.

10. A vehicle with a powertrain comprising at least one traction element powered by batteries, the batteries being housed in the internal volume of the housing according to claim 1.

11. The vehicle according to claim 10, wherein the batteries are lithium-ion batteries.

12. The housing according to claim 9, wherein the dimension transverse to the elongation direction is comprised between 0.85 mm and 0.9 mm.
